(19) United States
(12) Patent Application Publication
(10) Pub. No.: US 2009/0208614 A1
(43) Pub. Date: Aug. 20, 2009

(54) MICROWAVE FOOD PACKAGING

(75) Inventors: Richa Sharma, Aurora, OH (US); Kaj F. Knudsen, Avon, OH (US)

Correspondence Address: K&L Gates LLP, P.O. Box 1135, CHICAGO, IL, 60690, US

(73) Assignee: NESTEC S.A., Vevey (CH)

(21) Appl. No.: 12/303,351

(22) PCT Filed: May 23, 2007
(86) PCT No.: PCT/EP2007/055005

§ 371 Date: Jan. 21, 2009

Related U.S. Application Data
(60) Provisional application No. 60/812,055, filed on Jun. 8, 2006.

(51) Int. Cl. B65D 81/34; H05B 6/80; A23L 1/01

(52) U.S. Cl. 426/107; 219/729; 219/730; 426/113; 426/243

(57) ABSTRACT

Microwavable trays (2) and methods regarding same are provided. In an embodiment, the present invention provides a microwavable tray comprising a first compartment (10) for steaming foods, a second compartment (20) for moderately cooking foods, and a third compartment (30) for grilling or browning foods.

### BACKGROUND

The present invention is generally directed to food technology. More specifically, the present invention is directed to microwave food packaging and methods regarding same.

There are a variety of food packaging containers currently on the market. However, most of the existing microwavable frozen or refrigerated meal packages that contain individual food components tend to heat the components unevenly in a microwave oven. As a result, the separate food components in the microwavable meal package are not cooked to the desired level and/or quality.

Therefore, there is a need to provide improved food packaging for microwaving foods.

### SUMMARY

The present invention is directed to food packaging technology that comprises a microwaveable tray having different heating/shielding systems for the different food components of the microwavable meal. For example, the individual meal components can be placed in individual compartments that will be heated/shielded in their individually controlled cooking environments using a suitable microwave cooking technology.

In an embodiment, the present invention is directed to microwavable tray comprising a first compartment having a cover including a valve, a second compartment having at least one microwave shield, and a third compartment comprising a microwave susceptor. The second compartment and third compartment along with the first compartment can also have covers. The covers can be made of any suitable microwave covering material such as, for example, a film made from polymers, polypropylenes, plastics, polyesters and combinations thereof.

In an embodiment, the tray can comprise a material such as paper, paper board, plastics, polymers, polypropylene, polyethylene, crystalline polyethylene terephthalate and combinations thereof. The tray can have any suitable thickness such as, for example, between about 0.25 mm and 2.0 mm. The tray can comprise any suitable shape such as, for example, a square, a circle, a rectangle, an oval and combinations thereof. The tray can be any suitable length such as, for example, ranging between about 15 cm and 30 cm.

In an embodiment, the shield can comprises any suitable material for shielding microwaves such as, for example, metal, aluminium, paper, cardboard and combinations thereof. The second compartment can have one or more shields that cover a portion or all of its side walls, bottom and top.

In an embodiment, the susceptor can comprise a metallic film. The susceptor can defines a plurality of slits.

In an embodiment, the first compartment, second compartment and third compartment can be separated by weakening zones.

In another embodiment, the present invention provides a microwavable tray comprising at least two compartments, wherein each of the compartments includes at least one cooking technology selected from the group consisting of microwave susceptors, microwave shields, steam valves and combinations thereof.

In an alternative embodiment, the presenting invention provides a method for making a microwavable meal. For example, the method comprises providing a microwavable tray comprising first compartment having a cover including a valve, a second compartment having at least one microwave shield, and a third compartment comprising a microwave susceptor, placing individual foods in each compartment of the microwavable tray; and microwaving the foods in the microwavable tray at a sufficient power and time to cook the foods.

The first compartment can steam the food in the first compartment during the microwaving. The second compartment can moderately cook the food in the second compartment during the microwaving. Alternatively, the second compartment can prevent the food in the second compartment from being heated during the microwaving. The third compartment can grill or brown the food in the third compartment during the microwaving.

An advantage of the present invention is to provide a microwavable meal where each food component is cooked under optimal conditions.

Another advantage of the present invention is to provide a microwavable meal that has a restaurant-like or freshly-made appearance.

Additional features and advantages are described herein, and will be apparent from, the following Detailed Description and the figures.

### BRIEF DESCRIPTION OF THE FIGURES

FIG. 1 illustrates a top view of the food packaging in one embodiment of the present invention.

FIG. 2 illustrates a bottom view of the food packaging in one embodiment of the present invention.

FIG. 3 illustrates a top view the food packaging containing different food components in one embodiment of the present invention.

FIG. 4 illustrates a front perspective view the food components from the food packaging placed on a platter.

### DETAILED DESCRIPTION

The present invention is generally directed to food packaging technology. More specification, the present invention is directed to microwave food packages that can produce restaurant quality meals from frozen, refrigerated and/or shelf-stable prepared meals and snacks. For example, the food packages of the present invention uses innovative trays that utilize different microwave heating/shielding technologies such as, for example, steaming, shielding and susceptor technologies to heat under control the individual food or meal components. In various embodiments, the present invention provides the ability to steam foods in one compartment, grill or brown foods in another compartment and heat foods more slowly/keep food cool in a separate compartment of the same microwavable tray.

The new packaging concept along with the appropriate choice of product allows the consumer to have frozen meals cooked to restaurant quality in a microwave with minimum effort on their part. The ability of the microwavable package to cook different food components of the meal requiring different heating environments is expected to greatly improve the overall quality of the microwavable meal.

In an embodiment, the present invention provides a microwavable tray comprising at least two compartments with a distinct microwave technology for heating the food product in that compartment. For example, the individual compartments of the microwavable tray can use different heating/shielding technologies (or a combination of two or more heating/shielding technologies) such as, for example, as microwave susceptors, microwave shields and steam valves so that each individual component of the meal is cooked or moderately cooked to its desired quality or not cooked at all. As a result, each of the food components can be microwaved in an optimal manner and presented easily on a standard dinner plate in a visually appealing way.

In an alternative embodiment, the microwave tray can also be developed to use other suitable microwave heating technologies or combinations thereof depending upon the individual meal components and their heating requirements.

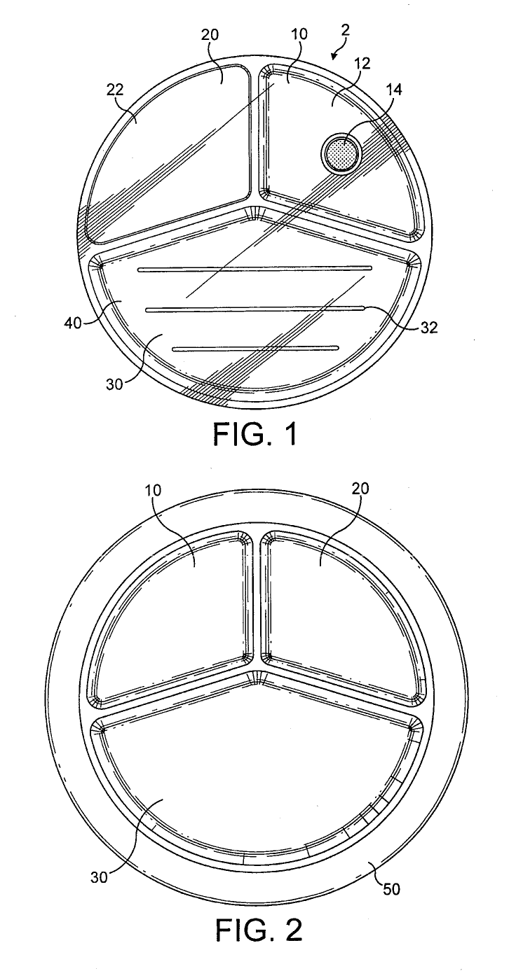

As illustrated in an embodiment in FIGS. 1-2, the present invention provides a microwavable tray 2 comprising a first compartment 10 having a cover 12 including a valve 14, a second compartment 20 having at least one microwave shield 22, and a third compartment 30 comprising a microwave susceptor 32. Each compartment can comprise a bottom and side walls and be attached to one or more of the other compartments in any suitable manner. The compartments can be sized and configured to store a variety of food components.

The microwave tray 2 can comprise any suitable microwavable material such as paper, paper board, plastics, polymers, polypropylene, polyethylene, crystalline polyethylene terephthalate and combinations thereof. It should be appreciated that the tray 2 can have any suitable thickness depending on the desired shape and strength characteristics for the tray. Preferably, the tray 2 has a thickness between about 0.25 mm and 2.0 mm.

The microwave tray 2 can comprise any suitable size or shape such as a square, a circle, a rectangle, an oval and combinations thereof. The microwave tray 2 can also have any suitable length or height. Preferably, the microwave tray 2 comprises a length ranging between about 15 cm and 30 cm.

The second compartment 20 and the third compartment 30 can also comprise a suitable cover or lid 40. For example, the covers for the first compartment 10, second compartment 20 and third compartment 30 can comprise a film selected from the group consisting of polymers, polypropylenes, plastics, polyesters and combinations thereof. The film or covers can be transparent or opaque. The film can be attached to the top of the separate compartments of the tray in any suitable manner such as, for example, using a removable or resealable adhesive. The film can also be applied to the tray by heat sealing.

The microwave shield 22 can comprise any suitable material for shielding or preventing microwaves from partially or entirely reaching the inside of the shielded second compartment 20. Suitable shielding materials can be, for example, metal, aluminium, paper, cardboard and combinations thereof. In an embodiment, the shielded compartment comprise a single microwave shield 22 covering the top of the second compartment 20. Alternatively, the shield can cover all or portions of the walls and/or bottom of the shielded compartment.

The amount of shielding in the shielded compartment can depend on the amount of microwave heating that is desired for the food in that compartment. For example, the more shielding that is used, the less heated the food in the compartment will be. In a preferred embodiment, the shielding technology can be used to keep a desert cool or used to heat it moderately compared to the rest of the microwavable food components in the tray.

The valve 14 of the first compartment 10 can be any suitable vent or channel that allows for a controlled moisture or steam release from the first compartment 10. For example, this compartment can contain fruits or vegetables or other food components that give off large amounts of steam when exposed to microwave. This not only allows the vegetable or similar cooked foods to be properly heated, but also prevents the moisture from these foods to interfere with the characteristics of the other microwavable food components that can be adversely affected by too much moisture (e.g. dough-based products).

In an embodiment, the microwave susceptor 32 can comprise a metallic film. The susceptor 32 can also define a plurality of slits for achieving a grilling pattern on foods. Typical foods that can go in this compartment include, for example, fish, meat, starch or dough-based products or other food components that can achieve browning, grilling or roasting using the susceptor in the microwave.

In another embodiment, the microwavable tray can be designed to have the different compartments at variable heights to accommodate the profiles of different meal components. As an example, the microwavable entrée can include the microwavable tray holding a stacked food product in a compartment having high side walls and the other food components can be in compartments with lower side walls.

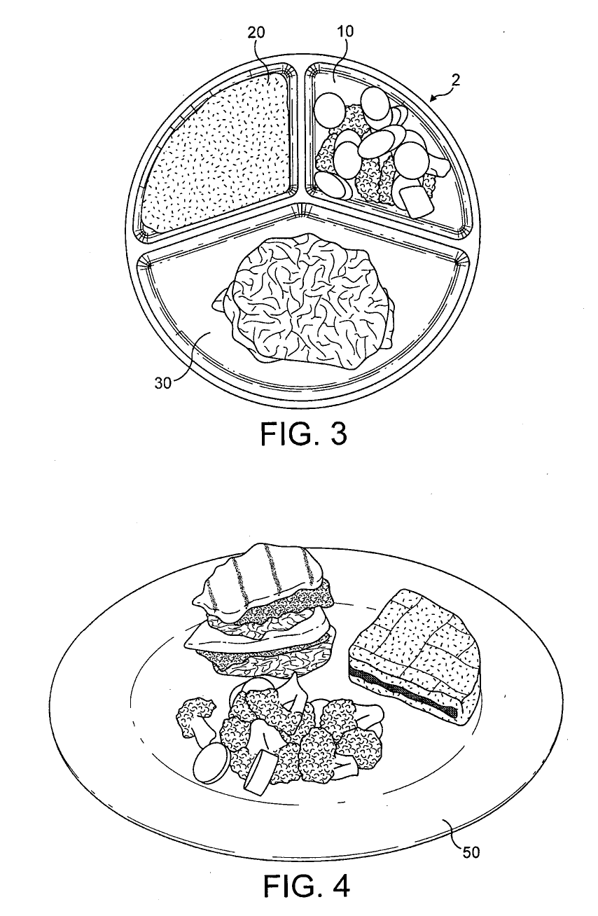

In an alternative embodiment illustrated in FIGS. 3-4, the microwavable tray 2 comprises food components that are assembled upside down in the tray. After the food items are cooked in the tray in the microwave, they can be flipped over a plate 50 so that the microwaved meal is placed right side up. This results in a nice presentation of the meal, which gives it a restaurant quality or freshly made appearance.

In an alternative embodiment, the present invention provides a tray having two or more compartments, wherein each compartment can be separated by weakening zones. In this embodiment, it is possible to snap (cut) apart one or more of the compartments so that it can be stored away in the freezer to be eaten separately. The tray can be designed such that the consumer can separate the specific food compartments through physical demarcations built in the tray (e.g. perforations, weak spots, laser scoring) between the compartments. Separating one or more for the compartments from the main meal can provide the additional benefit of not cooking a certain food component (e.g. desserts) in the oven with the rest of the meal tray.

Alternatively, the food component in the separated compartment can be cooked in its compartment individually to the level and texture desired by the consumer according to their individual preferences. Another benefit of breaking apart a certain compartment of the tray is to enable the consumer to keep that component frozen until it can be consumed at a later time after the meal is consumed (e.g. desserts, ice cream).

In another embodiment, the present invention provides microwavable tray comprising a first compartment having a refrigerated food, a second compartment having a shelf-stable food, and a third compartment having a frozen food. For example, each of the compartments includes at least one cooking technology selected from the group consisting of microwave susceptors, microwave shields, steam valves and combinations thereof that would be suitable for preparing that specific food type in a microwave oven. The foods can be microwaved in the microwavable tray at a sufficient power and time to cook or prepare the foods.

In an alternative embodiment, the presenting invention provides a method for making a microwavable meal. For example, the method can comprise providing a microwavable tray comprising first compartment having a cover including a valve, a second compartment having at least one microwave shield, and a third compartment comprising a microwave susceptor, placing individual foods in each compartment of the microwavable tray; and microwaving the foods in the microwavable tray at a sufficient power and time to cook the foods.

In this method, the first compartment can steam the food in the first compartment during the microwaving. The second compartment can moderately cook the food in the second compartment during the microwaving. Alternatively, the second compartment can prevent the food in the second compartment from being heated during the microwaving. The third compartment can grill or brown the food in the third compartment during the microwaving.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A microwavable tray comprising
a first compartment having a cover comprising a valve,
a second compartment having at least one microwave shield, and
a third compartment comprising a microwave susceptor.

2. The tray of claim 1, wherein the second compartment comprises a cover and the third compartment comprises a cover.

3. The tray of claim 1, wherein the tray comprises a material selected from the group consisting of paper, paper board, plastics, polymers, polypropylene, polyethylene, crystalline polyethylene terephthalate and combinations thereof.

4. The tray of claim 1, wherein the tray has a thickness of between about 0.25 mm and 2.0 mm.

5. The tray of claim 1, wherein the shield comprises a material selected from the group consisting of metal, aluminium, paper, cardboard and combinations thereof.

6. The tray of claim 1, wherein the second compartment comprises a bottom and the shield covers at least a portion of the bottom.

7. The tray of claim 1, wherein the second compartment comprises at least one side wall and the shield covers at least a portion of the side wall.

8. The tray of claim 2, wherein the covers for the first compartment, second compartment and third compartment comprise a film selected from the group consisting of polymers, polypropylenes, plastics, polyesters and combinations thereof.

9. The tray of claim 1, wherein the susceptor comprises a metallic film.

10. The tray of claim 1, wherein the susceptor defines a plurality of slits.

11. The tray of claim 1, wherein the first compartment, second compartment and third compartment are separated by zones of weakness.

12. The tray of claim 1, wherein the tray comprises a shape selected from the group consisting of a square, a circle, a rectangle, an oval and combinations thereof.

13. The tray of claim 1, wherein the tray has a length ranging from between about 15 cm to 30 cm.

14. A microwavable tray comprising at least two compartments, wherein each of the compartments includes at least one cooking technology selected from the group consisting of microwave susceptors, microwave shields, steam valves and combinations thereof.

15. A microwavable tray comprising
a first compartment having a refrigerated food,
a second compartment having a shelf-stable food, and
a third compartment having a frozen food.

16. The tray of claim 15, wherein each of the compartments includes at least one cooking technology selected from the group consisting of microwave susceptors, microwave shields, steam valves and combinations thereof.

17. A method for making a microwavable meal comprising:
providing a microwavable tray comprising a first compartment having a cover including a valve, a second compartment having at least one microwave shield, and a third compartment comprising a microwave susceptor,
placing individual foods in each compartment of the microwavable tray; and
microwaving the foods in the microwavable tray at a sufficient power and time to cook the foods.

18. The method of claim 17, wherein first compartment steams the food in the first compartment during the microwaving.

19. The method of claim 17, wherein second compartment moderately cooks the food in the second compartment during the microwaving.

20. The method of claim 17, wherein second compartment prevents the food in the second compartment from being heated during the microwaving.

21. The method of claim 17, wherein third compartment browns the food in the third compartment during the microwaving.

22. The method of claim 17, wherein the first compartment comprises a food selected from the group consisting a fruit, a vegetable and combinations thereof.

23. The method of claim 17, wherein the second compartment comprises a food selected from the group consisting of a dessert product, a pastry product and combinations thereof.

24. The method of claim 17, wherein the third compartment comprises a food selected from the group consisting of meat, starch-based food, dough-based food and combinations thereof.

25. A method for making a microwavable meal method comprising:
providing a microwavable tray comprising a first compartment having a refrigerated food, a second compartment having a shelf-stable food, and a third compartment having a frozen food; and
microwaving the foods in the microwavable tray at a sufficient power and time to cook the foods.

26. The method of claim 25, wherein each of the compartments includes at least one cooking technology selected from the group consisting of microwave susceptors, microwave shields, steam valves and combinations thereof.
